(19) United States
(12) Patent Application Publication
(10) Pub. No.: US 2015/0345924 A1
(43) Pub. Date: Dec. 3, 2015

(54) APPARATUS AND METHOD FOR MEASURING DEVICE MARKINGS

(71) Applicant: EDC MILLEN TOOLS, LLC, Hollywood, FL (US)

(72) Inventors: Gregory J. Millen, North Port, FL (US); David Carroll, North Miami Beach, FL (US)

(73) Assignee: EDC MILLEN TOOLS, LLC, Hollywood, FL (US)

(21) Appl. No.: 14/727,499

(22) Filed: Jun. 1, 2015

Related U.S. Application Data
(60) Provisional application No. 62/006,500, filed on Jun. 2, 2014.

(51) Int. Cl. G01B 3/10

(52) U.S. Cl. CPC G01B 3/1084; G01B 3/1061; G01B 3/1082; G01B 2003/1094; G01B 2003/1069

(57) ABSTRACT

The present invention is a measuring apparatus that is capable of facilitating the measurement of stud or truss placement behind a wall or beneath a roof. The invention comprises a measurement apparatus or system with indicators for informing the user of the exact measurement for the location of a stud behind a wall or a truss beneath a roof. Embodiments of the invention comprise: a retractable tape measure with such indicators visibly printed on the retractable tape, an optical projection system that projects a light image onto the work surface and indicates the location of studs or trusses on said work surface, and a retractable tape system that features flexible display technology and uses such technology to display indicators for stud and truss locations. The invention is customizable for configuration to the building codes or regulations of the region(s) in which the user is intending to use the apparatus or system.

### CROSS-REFERENCE TO RELATED APPLICATIONS

This U.S. Non-Provisional Patent Application claims the benefit of the currently pending, U.S. Provisional Patent Application No. 62/006,500, filed on 2 Jun. 2014, and is incorporated by reference as if fully set forth herein.

### FIELD OF THE INVENTION

This invention relates generally to the field of measuring devices, and, more particularly, to an original apparatus and related method for indicating to a user a series of predetermined spacings or measurements.

### BACKGROUND

Standard measuring devices, such as tape measures, are currently used to measure distances between wall studs. The way that individuals, do-it-yourself builders and carpenters are educated and trained to use these measuring devices results in confusion, mistakes, fatigue, and code failures because the measuring device is being used incorrectly. Residential and commercial building codes require wall studs to be placed 16″ on center and trusses to be placed 24″ on center. Currently, the way that most individuals use the measuring device is to hook it to the end of a layout plate and extend it to measure 16″ to the center of a wall stud and 24″ to the center of a truss. The individuals performing the layout are then instructed to search for and measure back ¾ inch from the 16″ or 24″ center line to locate the outside placement of the framing stud or truss and to mark an “X” on the layout plate to the right of the measurement in order to identify the stud or truss placement. This measuring and measuring back to accommodate for one-half of the stud or truss thickness is where errors occur. Inexperienced, fatigued, or careless builders may overlook the required step of measuring back from the “on-center” measurement. While seemingly innocuous, this type of error could lead to code failures and safety issues. For example, in a series of roof trusses, the roofer cannot see the trusses once the plywood is laid on top. In essence, the roofer is nailing “blind” and must trust that the trusses are in the correct location. The roofer relies on the 24″ center-to-center location of the roof trusses. If one, or many, is off by half the truss width, this could cause the roofer to miss the truss, causing a structural and safety issue, not to mention a building code violation.

It would, therefore, be desirable to have an original apparatus and related method for indicating to a user a series of predetermined spacing or measurements that clearly presents to the user not only the center-to-center spacing, but more importantly, the truss or stud edge location at the desired spacing.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification where a document, act, or item of knowledge is referred to or discussed, this reference or discussion is not an admission that the document, act, or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY

The present invention is directed to an original apparatus and related method for indicating to a user a series of predetermined spacings or measurements.

An embodiment of the invention may comprise a measuring device, such as a tape measure, as is known in the art, but improved to include highly visible markings at the ¾ inch measure of all 16-inch increments (for studs) and all 24-inch increments (for trusses). The markings would be color coded and different for studs and for trusses, with a “truss” or “stud” icon in the same color. Where the increments overlap, there would be dual color-coded markings, along with the appropriate icon(s).

In an embodiment of the invention comprising a method of using an embodiment of the apparatus, a user of the apparatus simply marks the spot as the apparatus indicates to note the placement of the stud or truss edge. This back measure marking system on measuring devices will ensure positive 16″ on center stud layout and 24″ on center truss layout over any distance. Accuracy and speed are ensured.

The present invention may address one or more of the problems and deficiencies of the prior art discussed above. However, it is contemplated that the invention may prove useful in addressing other problems and deficiencies in a number of technical areas. Therefore the claimed invention should not necessarily be construed as limited to addressing any of the particular problems or deficiencies discussed herein.

### BRIEF DESCRIPTION OF THE DRAWINGS

These and other features, aspects, and advantages of the present invention will become better understood with regard to the following description, appended claims, and accompanying drawings where:

FIG. 1 shows an embodiment of the prior art.

FIG. 2 shows an embodiment of the present invention.

FIG. 3 shows an embodiment of the present invention.

FIG. 4 shows a method utilizing an embodiment of the present invention.

### DESCRIPTION

In the Summary above, in the Description and appended Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, structures, steps, etc. are optionally present. For example, an article “comprising” (or “which comprises”) components A, B, and C can consist of (i.e., contain only) components A, B, and C, or can contain not only components A, B, and C but also one or more other components or structures.

The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

While the specification will conclude with claims defining the features of embodiments of the invention that are regarded as novel, it is believed that the invention will be better understood from a consideration of the following description in conjunction with the figures, in which like reference numerals are carried forward.

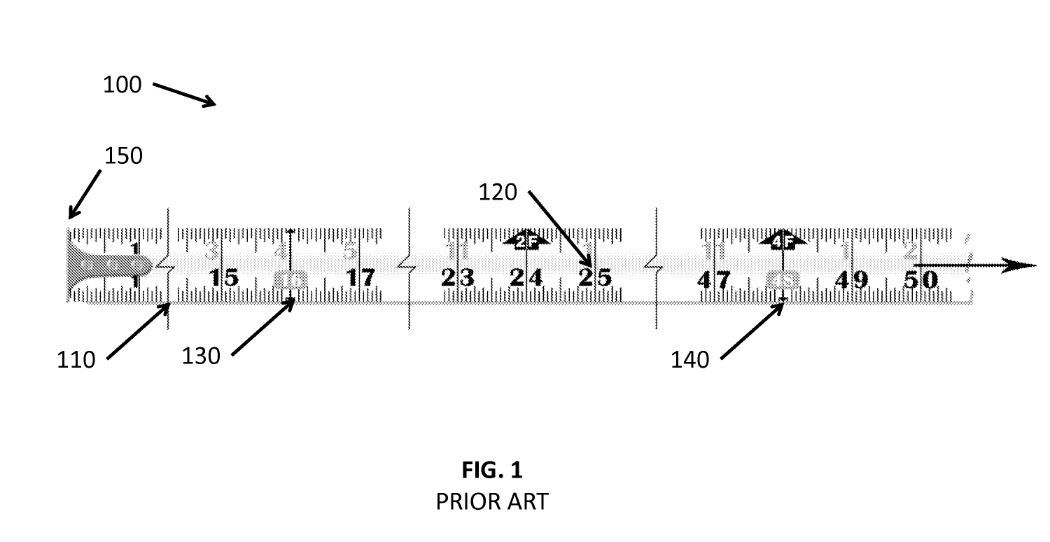

Referring to FIG. 1, the prior art discloses a typical measuring device 100 in the form of a retractable tape measure 110 with pre-printed markings 120 between a proximal end (not shown) and a distal end 150. As is the custom in the United States, wall studs are spaced 16″ center-to-center 130, and roof trusses are spaced 24″ center-to-center 140. The prior art measuring devices will typically have a special marking at multiples of 16″ and at multiples of 48″.

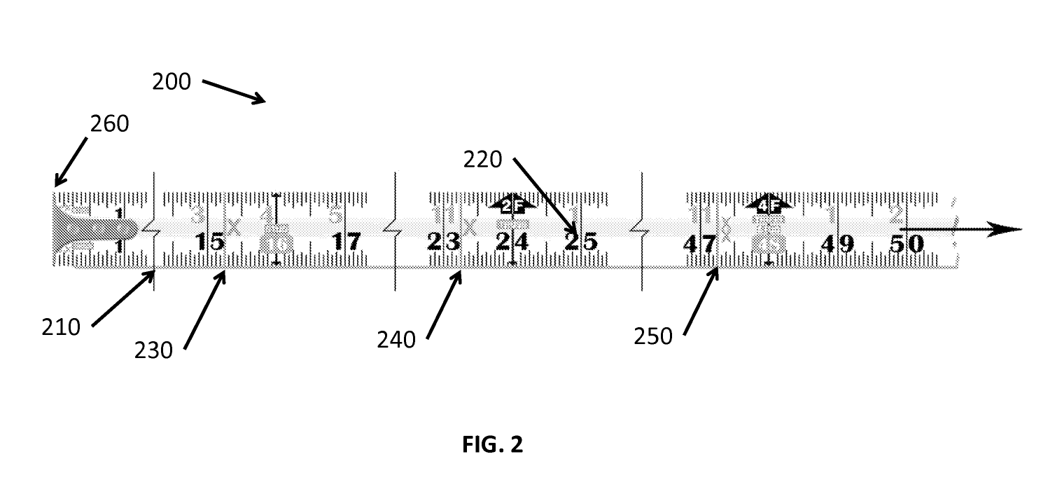

Referring to FIG. 2, a preferred embodiment of the present invention comprises a measuring device 200 in the form of a retractable tape measure 210 with pre-printed markings 220 between a proximal end (not shown) and a distal end 260, highly visible markings at the ¾ inch back-measure of all 16-inch increments (for studs) 230, and highly visible markings at the ¾ inch back-measure of all 24-inch increments (for trusses) 240. The markings in this embodiment may be color coded and different for studs and for trusses. Further embodiments may include a “truss” or “stud” icon in the same color. Where the increments overlap, there would be dual color-coded markings 250, along with the appropriate icon(s).

It is contemplated as part of the present invention that embodiments thereof may employ various spacing schemes and corresponding back-markings as dictated by local building codes.

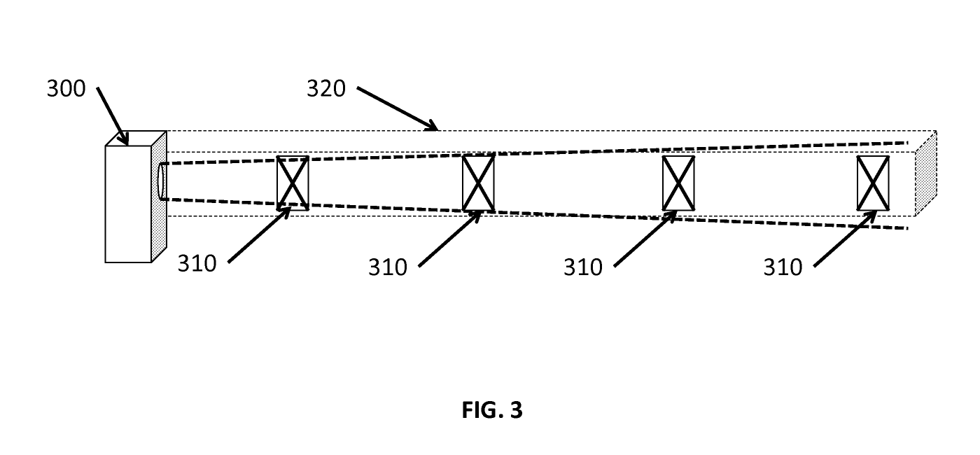

Another embodiment of the present invention is shown in FIG. 3 and comprises a measurement device 300 in the form of an optical projection system configured to accurately project the proper stud or truss location 310 onto a surface 320, as described herein, based upon the selected building code. Embodiments are contemplated to include, but are not limited to laser-based systems that utilize one or more lasers to measure distance as well as to project visible markings. Such embodiments may comprise a laser, an optical focusing system, a processor, a memory storage medium, a user interface, and a power supply. It is contemplated that in such embodiments, the processor would be configured so as to read instructions from the memory storage medium and control the laser to project the chosen spacing scheme. The user, through the user interface, may select the desired spacing scheme from one or more available choices that are pre-programmed onto the memory storage medium.

Further embodiments of the present invention may comprise a retractable tape, a processor, a memory storage medium, and a power supply, wherein said retractable tape may be flexible display technology, such as “e-ink”. The processor may be programmed to receive instructions from the memory storage medium to dynamically display on the retractable tape the pre-programmed spacing scheme desired by the user. The power supply may supply power to the processor, memory storage medium, and display. Such embodiments may further comprise a user interface for selecting the desired spacing scheme from the schemes pre-loaded onto the memory storage medium.

Embodiments such as those previously disclosed may further comprise a system for upgrading the memory or of loading new spacing schemes. It is contemplated that this may be accomplished in many ways known in the art including, but not limited to, removable storage mediums such as SD-cards, input-output interfaces such as USB, or utilizing wireless communication protocols.

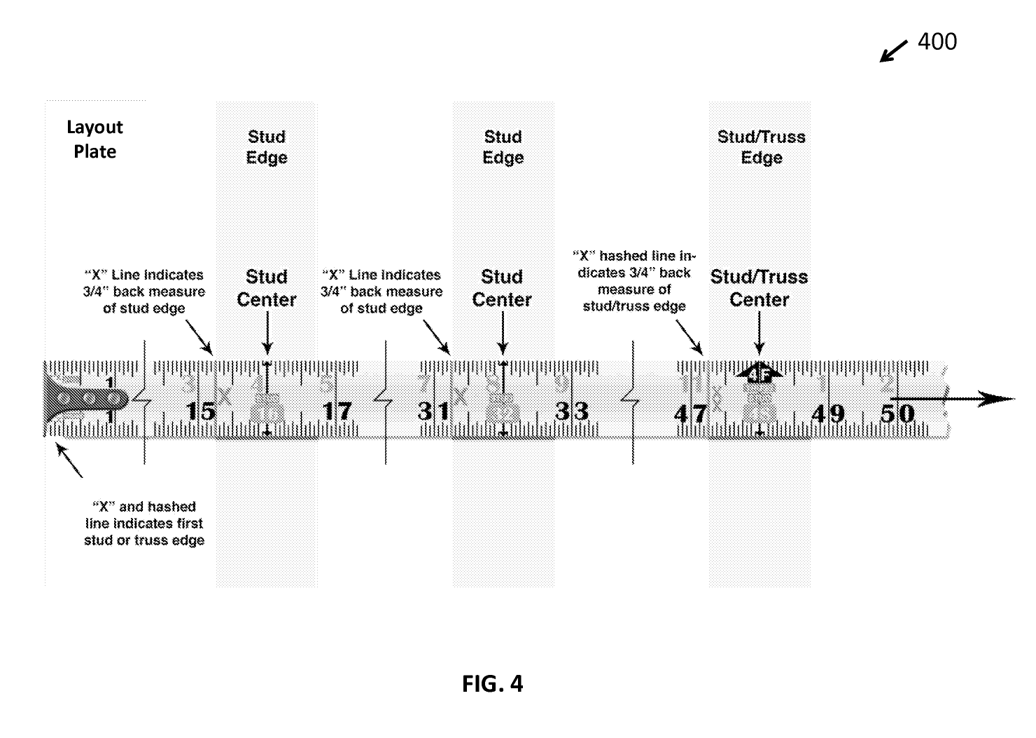

Referring to FIG. 4, an embodiment of the present invention comprising a method 400 of using a preferred embodiment of the apparatus. A user of the apparatus indexes the apparatus to a layout plate on the building. The user then extends the apparatus along the trajectory of the stud or truss layout and simply marks the spot as the apparatus indicates to note the placement of the stud or truss edge. This back measure marking system on measuring devices will ensure positive 16″ on center stud layout and 24″ on center truss layout over any distance. Accuracy and speed are ensured.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

What is claimed is:

1. A retractable tape measure comprising:
a retractable tape with a proximal end and distal end;
a multitude of calibration markings between said proximal end and said distal end, said calibration markings printed on said retractable tape, starting at said distal end and incrementally increasing towards said proximal end;
a multitude of stud markings, on said retractable tape, distinguishable from said calibration markings, at the 15.25-inch calibration mark and every 16-inch increment therefrom; and
a multitude of truss markings, on said retractable tape, distinguishable from said stud markings and said calibration markings, at the 23.25-inch calibration mark and every 24-inch increment therefrom.

2. The retractable tape measure according to claim 1, wherein:
said stud markings are colored in a different color from said calibration markings; and
said distinguishable truss markings are colored in a different color from said calibration markings and said stud markings.

3. The retractable tape measure according to claim 1, wherein:
said stud markings are in the form of primary icons printed on said retractable tape; and
said truss markings are in the form of secondary icons printed on said retractable tape, said secondary icons distinguishable from said primary icons.

4. A an optical projection system, the system comprising:
a laser;
a memory storage medium having predetermined instructions for spacing schemes;
a processor, said processor electrically connected to said laser and to said memory storage medium, said processor configured to read instructions from said memory storage medium and control said laser to project a spacing scheme;
a means for measuring distance, said means for measuring distance electrically connected to said processor, and capable of measuring the distance between said laser and a surface and outputting a distance measurement;
an optical focusing system, said optical focusing system electrically connected to said processor, and capable of receiving said distance measurement and focusing a light emission from said laser in accordance thereto;
a power supply, said power supply electrically connected to said processor; and
a user interface, said user interface electrically connected to said processor.

5. The optical projection system according to claim 4, wherein said user interface is capable of allowing a user to select a spacing scheme from a multitude of spacing schemes.

6. The optical projection system according to claim 4, wherein said memory storage medium is removable.

7. A retractable tape system comprising:
a retractable tape, said retractable tape featuring flexible display technology;
a processor; said processor electrically connected to said flexible display technology;
a memory storage medium, said memory storage medium electrically connected to said processor; and
a power supply, said power supply electrically connected to said processor.

8. The retractable tape system according to claim 7, wherein said processor is programed to receive instructions from said memory storage medium and display a spacing scheme.

9. The retractable tape system according to claim 7, further comprising a user interface for selecting a spacing scheme from a host of spacing schemes.

10. The retractable tape system according to claim 7, wherein said flexible display technology is “e-ink” technology.

11. The retractable tape system according to claim 7, wherein said memory storage medium is removable.
